(19) United States
(12) Patent Application Publication
(10) Pub. No.: US 2025/0019111 A1
(43) Pub. Date: Jan. 16, 2025

(54) Label Pasting Device and Method

(71) Applicants: TE Connectivity Solutions GmbH, Schaffhausen (CH); Tyco Electronics (Shanghai) Co., Ltd., Shanghai (CN)

(72) Inventors: Zongjie (Jason) Tao, Shanghai (CN); Dandan (Emily) Zhang, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 18/768,318

(22) Filed: Jul. 10, 2024

(30) Foreign Application Priority Data
Jul. 10, 2023 (CN) 202310843282.0

(51) Int. Cl. B65C 3/02; B25J 15/06; B65C 9/06; B65C 9/08; B65C 9/36

(52) U.S. Cl. CPC B65C 3/02; B25J 15/0616; B65C 9/06; B65C 9/08; B65C 9/36

(57) ABSTRACT

A label pasting device includes a clamping mechanism and a rotating mechanism. The clamping mechanism has a vacuum suction hole and a pair of grippers. The vacuum suction hole adsorbs onto a vertical part of a T-shaped label to pick up the T-shaped label. The grippers are openable and closable to fold and paste the vertical part of the T-shaped label onto a cable. The rotating mechanism has a fixed plate and a rotatable plate. The fixed plate supports an upper half of a horizontal part of the T-shaped label from a back. The rotatable plate is openable and closable relative to the fixed plate to fold and paste a lower half of the horizontal part of the T-shaped label onto the upper half.

### CROSS-REFERENCE TO RELATED APPLICATION

This application claims the benefit of the filing date under 35 U.S.C. § 119(a)-(d) of Chinese Patent Application No. 202310843282.0, filed on Jul. 10, 2023.

### FIELD OF THE INVENTION

The present invention relates to a label pasting device and a label pasting method, in particular to a label pasting device and a label pasting method for pasting a T-shaped label onto a cable.

### BACKGROUND OF THE INVENTION

In the prior art, a T-shaped label is usually manually pasted to a cable. However, the efficiency of manually pasting T-shaped label is very low and is very time-consuming and laborious.

### SUMMARY OF THE INVENTION

A label pasting device includes a clamping mechanism and a rotating mechanism. The clamping mechanism has a vacuum suction hole and a pair of grippers. The vacuum suction hole adsorbs onto a vertical part of a T-shaped label to pick up the T-shaped label. The grippers are openable and closable to fold and paste the vertical part of the T-shaped label onto a cable. The rotating mechanism has a fixed plate and a rotatable plate. The fixed plate supports an upper half of a horizontal part of the T-shaped label from a back. The rotatable plate is openable and closable relative to the fixed plate to fold and paste a lower half of the horizontal part of the T-shaped label onto the upper half.

### BRIEF DESCRIPTION OF THE DRAWINGS

Features of the present invention will become more apparent by describing in detail exemplary embodiments thereof with reference to the accompanying drawings, in which:

FIG. 1 shows an illustrative view of a clamping mechanism of a label pasting device according to an exemplary embodiment of the present invention, wherein a pair of grippers of the clamping mechanism are in an opened position and the T-shaped label is vacuum adsorbed onto the clamping mechanism;

FIG. 2 shows an illustrative view of a T-shaped label and cable according to an exemplary embodiment of the present invention, wherein the T-shaped label has not yet been pasted to the cable;

FIG. 3 shows an illustrative view of a clamping mechanism of a label pasting device according to an exemplary embodiment of the present invention, wherein the clamping mechanism is moved towards the cable so that the cable enters the pair of grippers through the opening of the opened pair of grippers;

FIG. 4 shows an illustrative view of a clamping mechanism of a label pasting device according to an exemplary embodiment of the present invention, wherein the pair of grippers of the clamping mechanism are closed to grip the folded vertical part of the T-shaped label;

FIG. 5 shows an illustrative view of a T-shaped label and cable according to an exemplary embodiment of the present invention, wherein the vertical part of the T-shaped label has been folded and pasted onto the cable;

FIG. 6 shows an illustrative view of a rotating mechanism of a label pasting device according to an exemplary embodiment of the present invention, wherein the fixed plate and rotatable plate of the rotating mechanism are respectively attached to the back surfaces of the upper half and lower half of the horizontal part of the T-shaped label;

FIG. 7 shows an illustrative view of a rotating mechanism of a label pasting device according to an exemplary embodiment of the present invention, wherein the rotatable plate of the rotating mechanism rotates from the opened position to the closed position, so that the lower half of the horizontal part of the T-shaped label is folded and pasted onto the upper half; and

FIG. 8 shows an illustrative view of a T-shaped label and cable according to an exemplary embodiment of the present invention, wherein the lower half of the horizontal part of the T-shaped label is folded and pasted onto the upper half.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

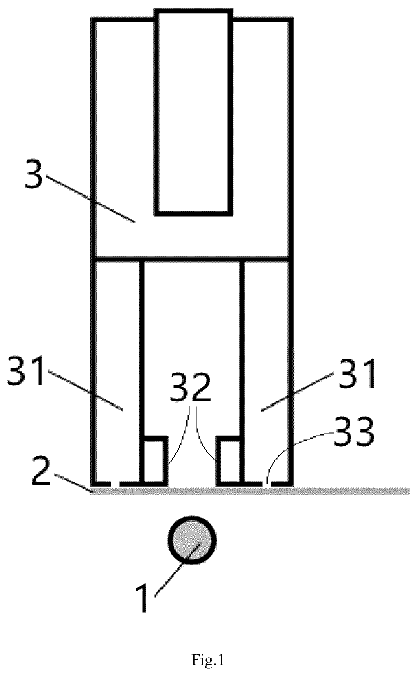

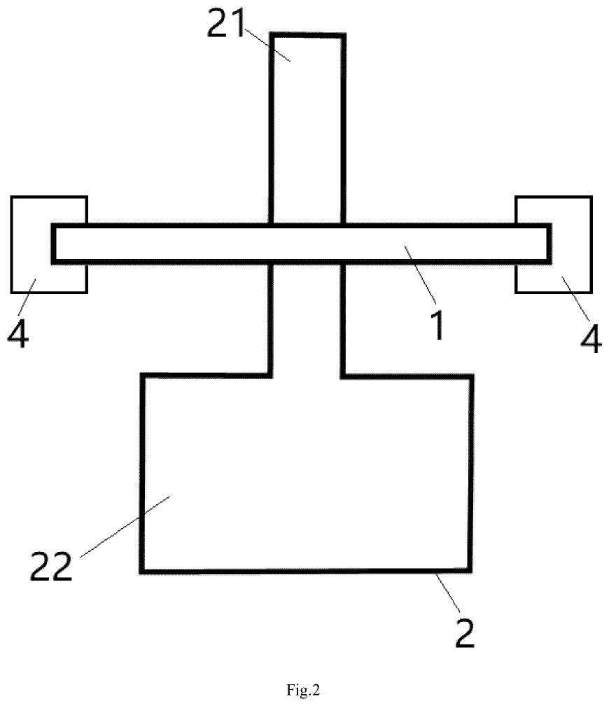

As shown in FIGS. 1 to 8, in an exemplary embodiment of the present invention, a label pasting device is disclosed. This label pasting device is used to paste a T-shaped label 2 to a cable 1. In the illustrated embodiment, the T-shaped label 2 includes a vertical part 21 and a horizontal part 22, as shown in FIG. 2. The vertical part 21 of T-shaped label 2 is connected to the middle position of the upper side of the horizontal part 22 of T-shaped label 2.

As shown in FIGS. 1 to 8, in the illustrated embodiments, the label pasting device comprises a clamping mechanism 3 and a rotating mechanism 5. The clamping mechanism 3 includes a vacuum suction hole 33 and a pair of clamping grippers 31. The vacuum suction hole 33 can be formed on each of the grippers 31 of the clamping mechanism 3 or on other components of the clamping mechanism 3. The vacuum suction hole 33 is used to adsorb onto the vertical part 21 of the T-shaped label 2 to pick up the T-shaped label 2, as shown in FIG. 1. The pair of grippers 31 of the clamping mechanism 3 can be opened and closed, used to fold, and paste the vertical part 21 of the picked up T-shaped label 2 onto a cable 1.

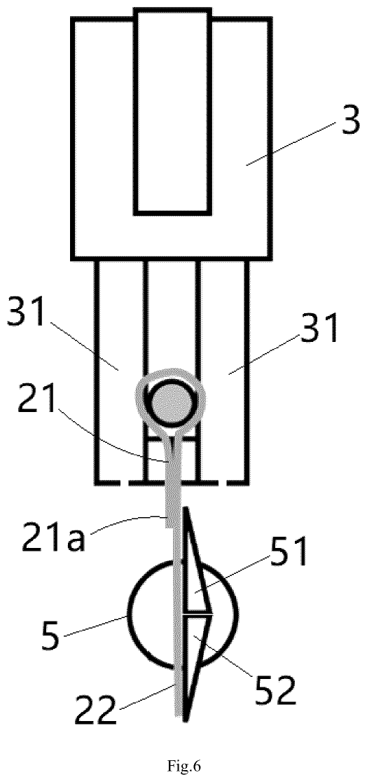

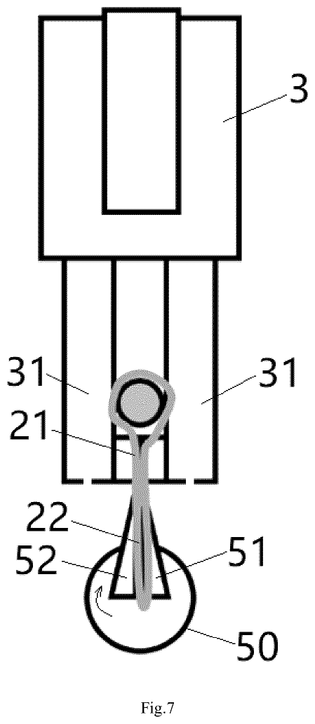

As shown in FIGS. 6 and 7, in the illustrated embodiments, the rotating mechanism 5 comprises a fixed plate 51 and a rotatable plate 52. The fixed plate 51 is used to support the upper half of the horizontal part 22 of the T-shaped label 2 from the back. The rotatable plate 52 can be rotated to open and close relative to the fixed plate 51, in order to fold and paste the lower half of the horizontal part 22 of the T-shaped label 2 onto the upper half of the horizontal part 22 of the T-shaped label 2. In the illustrated embodiments, the rotating mechanism 5 further includes a base 50. The fixed plate 51 is fixedly installed on the base 50, and the rotatable plate 52 is rotatably installed on the base 50.

In the illustrated embodiments, the label pasting device further includes a cable clamp 4, as shown in FIG. 2, which is used to clamp and fix the cable 1, so that the cable 1 is maintained in an orientation perpendicular to the vertical part 21 of the T-shaped label 2 picked up by the clamping mechanism 3.

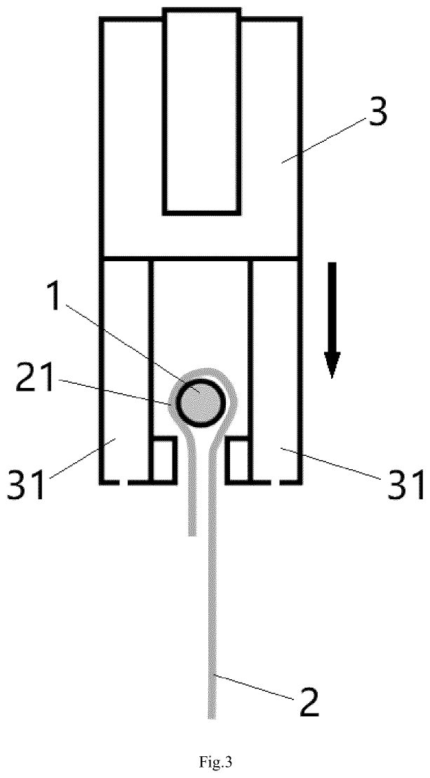

After picking up the T-shaped label 2, the clamping mechanism 3 is moved towards the cable 1 in a direction perpendicular to the cable 1, allowing the cable 1 to enter the opened pair of grippers 31 through the opening between them, as shown in FIG. 3, and folding and pasting the vertical part 21 of the T-shaped label 2 along the axial direction of the cable 1 onto the cable 1. After the cable 1 is fixed to cable clamp 4, the cable 1 is aligned with the opening between the open pair of grippers 31 in the radial direction of the cable 1, so that cable 1 can enter the opened pair of grippers 31 along the radial direction of the cable 1.

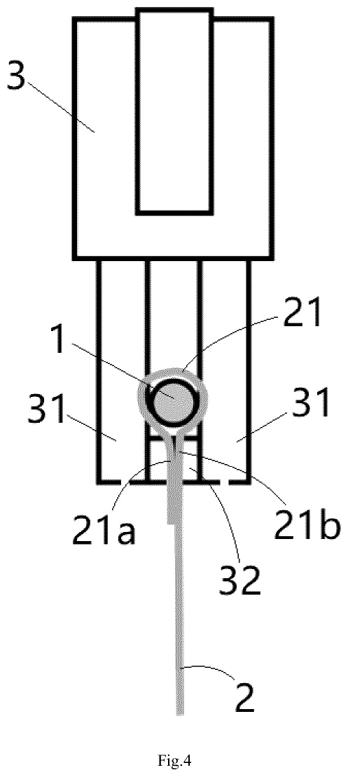

As shown in FIGS. 1 and 4, in the illustrated embodiments, clamping protrusions 32 are respectively formed on the inner sides of the ends of the pair of grippers 31, and the clamping protrusion 32 has a flat clamping surface. After the cable 1 enters the opened pair of grippers 31, the pair of grippers 31 is closed, causing an end 21a and a root 21b of the vertical part 21 of T-shaped label 2 to be clamped between the clamping surfaces of the clamping protrusion 32 of the pair of grippers 31, in order to paste the end 21a and root 21b of the vertical part 21 of T-shaped label 2 together.

In the illustrated embodiments, the gripper 31 has a flat end face adapted to adhere to the surface of the vertical part 21 of the T-shaped label 2, and the vacuum suction hole 33 is formed on the flat end face of the gripper 31. In this way, the T-shaped label 2 can be sucked through the vacuum suction holes 33 on the flat end faces of the pair of grippers 31, as shown in FIG. 1.

As shown in FIGS. 6 and 7, in the illustrated embodiments, the fixed plate 51 and the rotatable plate 52 of the rotating mechanism 5 have flat surfaces suitable for attaching to the back surfaces of the upper and lower halves of the horizontal part 22 of the T-shaped label 2, respectively.

After the vertical part 21 of T-shaped label 2 is folded and pasted onto the cable 1, the rotating mechanism 5 is moved so that the fixed plate 51 and the rotatable plate 52 of the rotating mechanism 5 are respectively attached onto the back surfaces of the upper and lower halves of the horizontal part 22 of T-shaped label 2, as shown in FIG. 6.

In the illustrated embodiments, during the process of closing the pair of grippers 31 of the clamping mechanism 3, the rotating mechanism 5 is moved so that the fixed plate 51 and the rotatable plate 52 of the rotating mechanism 5 are respectively attached to the back surfaces of the upper and lower halves of the horizontal part 22 of the T-shaped label 2. This can save time and improve efficiency.

After the fixed plate 51 and the rotatable plate 52 of the rotating mechanism 5 are respectively attached to the back surfaces of the upper and lower halves of the horizontal part 22 of the T-shaped label 2, the rotatable plate 52 is rotated from the opened position to the closed position, so that the lower half of the horizontal part 22 of the T-shaped label 2 is folded and pasted onto the upper half of the horizontal part 22 of the T-shaped label 2, as shown in FIG. 7. When the rotatable plate 52 is rotated to the closed position, the lower and upper halves of the horizontal part 22 of the T-shaped label 2 are clamped between the fixed plate 51 and the rotatable plate 52, causing the lower and upper halves of the horizontal part 22 of the T-shaped label 2 to be pasted together.

In the illustrated embodiments, after the end 21a and the root 21b of the vertical part 21 of T-shaped label 2 are pasted together, a portion of the end 21a of the vertical part 21 of T-shaped label 2 is overlapped on the upper half of the horizontal part 22 of T-shaped label 2. After the lower and upper halves of the horizontal part 22 of T-shaped label 2 are pasted together, a portion of the lower half of the horizontal part 22 of T-shaped label 2 is overlapped on the end 21a of the vertical part 21 of T-shaped label 2.

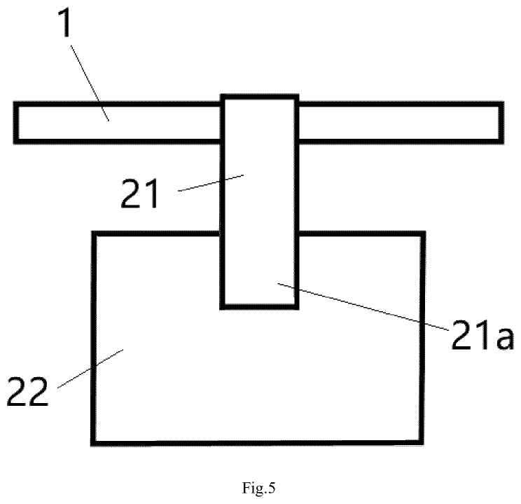

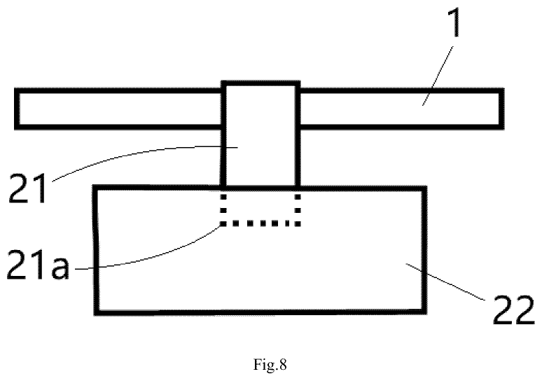

In another exemplary embodiment of the present invention, a label pasting method is also disclosed. The label pasting method includes the following steps of:
S10: providing the aforementioned label pasting device;
S20: as shown in FIG. 2, using the cable clamp 4 to clamp and fix the cable 1;
S30: as shown in FIG. 1, using the clamping mechanism 3 to vacuum suction the vertical part 21 of the T-shaped label 2;
S40: as shown in FIG. 3, moving the clamping mechanism 3 towards the cable 1, so that the cable 1 enters the opened pair of grippers 31 of the clamping mechanism 3, and causes the vertical part 21 of the T-shaped label 2 to be folded and pasted onto the cable 1 along the axial direction of cable 1;
S50: as shown in FIGS. 4 and 5, closing the pair of grippers 31 of the clamping mechanism 3 to clamp and paste the end 21a and the root 21b of the vertical part 21 of the T-shaped label 2 together;
S60: as shown in FIG. 6, moving the rotating mechanism 5 so that the fixed plate 51 and the rotatable plate 52 of the rotating mechanism 5 are respectively attached to the back surfaces of the upper half and lower half of the horizontal part 22 of the T-shaped label 2; and
S70: as shown in FIGS. 7 and 8, rotating the rotatable plate 52 from the opened position to the closed position, so that the lower half of the horizontal part 22 of T-shaped label 2 is folded and pasted onto the upper half of the horizontal part 22 of T-shaped label 2.

In the illustrated embodiments, the aforementioned steps S50 and S60 can be performed simultaneously, which can save time and improve efficiency.

In the aforementioned exemplary embodiments of the present invention, the label pasting device can automatically paste the T-shaped label 2 to the cable 1, improving the efficiency of pasting T-shaped label 2. Moreover, the label pasting device of the present invention has a simple structure and is easy to operate.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A label pasting device, comprising:
a clamping mechanism including a vacuum suction hole and a pair of grippers, the vacuum suction hole adsorbing onto a vertical part of a T-shaped label to pick up the T-shaped label, the grippers are openable and closable to fold and paste the vertical part of the T-shaped label onto a cable; and
a rotating mechanism including a fixed plate and a rotatable plate, the fixed plate supports an upper half of a horizontal part of the T-shaped label from a back, the rotatable plate is openable and closable relative to the fixed plate to fold and paste a lower half of the horizontal part of the T-shaped label onto the upper half.

2. The label pasting device of claim 1, further comprising a cable clamp clamping and fixing the cable to maintain the cable in an orientation perpendicular to the vertical part of the T-shaped label.

3. The label pasting device of claim 2, wherein, after picking up the T-shaped label, the clamping mechanism is moved in a direction perpendicular to the cable toward the cable, the cable enters the pair of grippers to fold and paste the vertical part of the T-shaped label onto the cable along an axis of the cable.

4. The label pasting device of claim 3, wherein, after the cable is fixed to the cable clamp, the cable is aligned with an opening of the pair of grippers in a radial direction of the cable, so that the cable can enter the pair of grippers in the radial direction.

5. The label pasting device of claim 1, wherein an inner side of an end of each of the pair of grippers has a clamping protrusion with a clamping surface.

6. The label pasting device of claim 5, wherein, after the cable enters the pair of grippers, the pair of grippers is closed and an end and a root of the vertical part of the T-shaped label are clamped between the clamping surfaces of the clamping protrusions to paste the end and the root together.

7. The label pasting device of claim 6, wherein each of the grippers has a flat end face attached to a surface of the vertical part of the T-shaped label, the vacuum suction hole is formed on the flat end face of each of the grippers.

8. The label pasting device of claim 6, wherein the fixed plate of the rotating mechanism has a flat surface that attaches to a back surface of the upper half of the horizontal part of the T-shaped label and the rotatable plate of the rotating mechanism has a flat surface that attaches to a back surface of the lower half of the horizontal part of the T-shaped label.

9. The label pasting device of claim 8, wherein, after the vertical part of the T-shaped label is folded and pasted onto the cable, the rotating mechanism is moved so that the fixed plate and the rotatable plate of the rotating mechanism are attached to the back surfaces of the upper half and the lower half of the horizontal part of the T-shaped label.

10. The label pasting device of claim 8, wherein, while closing the grippers of the clamping mechanism, the rotating mechanism moves so that the fixed plate and the rotatable plate of the rotating mechanism are respectively attached onto the back surfaces of the upper half and the lower half of the horizontal part of the T-shaped label.

11. The label pasting device of claim 9, wherein, after the fixed plate and the rotatable plate of the rotating mechanism are respectively attached onto the back surfaces of the upper half and the lower half of the horizontal part of the T-shaped label, the rotatable plate is rotated from an opened position to a closed position, so that the lower half of the horizontal part of the T-shaped label is folded and pasted onto the upper half.

12. The label pasting device of claim 11, wherein, when the rotatable plate is rotated to the closed position, the lower half and the upper half of the horizontal part of the T-shaped label are clamped between the fixed plate and the rotatable plate, so that the lower half and the upper half of the horizontal part of the T-shaped label are pasted together.

13. The label pasting device of claim 12, wherein, after the end and the root of the vertical part of the T-shaped label are pasted together, a portion of the end of the vertical part of the T-shaped label is overlapped on the upper half of the horizontal part of the T-shaped label.

14. The label pasting device of claim 13, wherein after the lower half and the upper half of the horizontal part of the T-shaped label are pasted together, a portion of the lower half of the horizontal part of the T-shaped label is overlapped on the end of the vertical part of the T-shaped label.

15. The label pasting device of claim 1, wherein the rotating mechanism has a base, the fixed plate is fixedly installed on the base and the rotatable plate is rotatably installed on the base.

16. A label pasting method, comprising:
providing a label pasting device including a clamping mechanism, a rotating mechanism, and a cable clamp, the clamping mechanism has a vacuum suction hole and a pair of grippers, the rotating mechanism has a fixed plate and a rotatable plate;
clamping a cable with the cable clamp;
adsorbing a vertical part of a T-shaped label to the clamping mechanism using the vacuum suction hole;
moving the clamping mechanism toward the cable to that the cable enters the pair of grippers and the vertical part of the T-shaped label is folded and pasted along an axis of the cable onto the cable;
closing the pair of grippers of the clamping mechanism to clamp and paste an end and a root of the vertical part of the T-shaped label together;
moving the rotating mechanism so that the fixed plate and the rotatable plate are respectively attached to a back surface of an upper half and a back surface of a lower half of a horizontal part of the T-shaped label; and
rotating the rotatable plate from an opened position to a closed position, so that the lower half of the horizontal part of the T-shaped label is folded and pasted onto the upper half.

17. The method of claim 16, wherein the closing step and the step of moving the rotating mechanism are performed simultaneously.
